(19) United States
(12) Patent Application Publication
(10) Pub. No.: US 2024/0300046 A1
(43) Pub. Date: Sep. 12, 2024

(54) WELDING APPARATUS AND PROGRAM

(71) Applicant: FANUC CORPORATION, Yamanashi (JP)

(72) Inventors: Sayuki KASHIWAGI, Yamanashi (JP); Yasuhiro AMAGATA, Yamanashi (JP)

(21) Appl. No.: 18/574,468

(22) PCT Filed: Aug. 6, 2021
(86) PCT No.: PCT/JP2021/029439

§ 371 Date: Dec. 27, 2023

(51) Int. Cl. B23K 11/11; B23K 11/25

(52) U.S. Cl. CPC B23K 11/115; B23K 11/253; B23K 11/255

(57) ABSTRACT

A welding apparatus includes a module for prompting a user to input a command indicating that a welding pressure between a movable electrode tip and a fixed electrode tip has reached each of two welding pressures, a module for identifying a torque exerted in the servo motor and a movement amount of the movable electrode tip at a point in time when the command is input, a module for deriving a relational expression between the welding pressure and the movement amount, a module for using the relational expression to estimate a movement amount of the movable electrode tip required to generate another welding pressure, and a module for identifying a torque required for the movable electrode tip to move the estimated movement amount, and registering the torque in association with the another welding pressure.

### TECHNICAL FIELD

This disclosure relates generally to a welding apparatus and a program.

### BACKGROUND ART

In recent years, the use of robot apparatuses equipped with spot welding guns for welding car bodies and the like has become widespread. In welding work using a spot welding gun, two workpieces to be welded are sandwiched between a movable electrode tip and a fixed electrode tip, and an electric current is applied to the movable electrode tip and the fixed electrode tip while a predetermined welding pressure is being applied thereto, thereby welding two workpieces to be welded. With respect to the welding using a spot welding gun. Patent Literature 1 discloses a spot welding system that can easily calculate, with high accuracy, the elastic displacement of a gun arm when pressurizing a workpiece to be welded, in order to suppress deterioration of welding accuracy.

In order to suppress the deterioration of welding accuracy, it is also an important factor to accurately apply a welding pressure adjusted according to the thickness and material of the workpiece to be welded and the required welding strength. This welding pressure is adjusted by the torque of a servo motor that drives the movement of a movable electrode tip. In order to adjust the welding pressure by the torque, the relationship between the welding pressure and the torque is registered in advance. However, the relationship between the welding pressure and the torque may change due to some factors such as deterioration of the servo motor and deterioration of the electrode tip. Therefore, it is necessary to calibrate the relationship between the welding pressure and the torque before using the spot welding gun.

### CITATION LIST

### Patent Literature

Patent Literature 1: Japanese Unexamined Patent Application Publication No. 2015-217436

### BRIEF DESCRIPTION OF THE DRAWINGS

FIG. 1 is a diagram showing an example of a welding apparatus according to the present embodiment.

FIG. 2 is an enlarged view of a spot welding gun in FIG. 1.

FIG. 3 is a block configuration diagram of the welding apparatus according to the present embodiment.

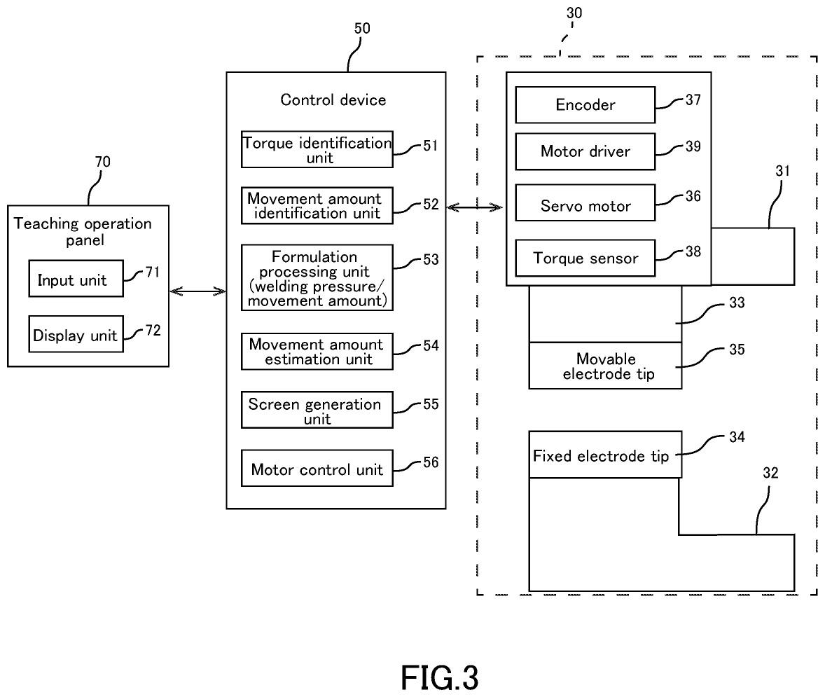

FIG. 4 is a flowchart showing an example of a calibration procedure by the welding apparatus according to the present embodiment.

FIG. 5 is a diagram showing an example of a calibration screen corresponding to step S11 of the calibration procedure in FIG. 4.

FIG. 6 is a diagram showing an example of a calibration screen corresponding to steps S12, S15, and S16 of the calibration procedure in FIG. 4.

FIG. 7 is a supplementary diagram for explaining internal processing of a control device corresponding to steps S13 and S14 of the calibration procedure in FIG. 4.

### DETAILED DESCRIPTION OF THE INVENTION

A welding apparatus according to one aspect of the present disclosure is provided with a welding gun including a servo motor configured to generate power for causing a movable electrode tip to approach and separate from a fixed electrode tip in order to pressurize a workpiece to be welded between the movable electrode tip and the fixed electrode tip for welding. The welding apparatus includes means for prompting a user to input a plurality of welding pressures to be used for the welding, means for prompting the user to input a command indicating that a welding pressure between the movable electrode tip and the fixed electrode tip has reached each of two welding pressures among the plurality of welding pressures, means for identifying a torque exerted in the servo motor at a point in time when the command is input, means for identifying movement amounts of the movable electrode tip required for the welding pressure between the movable electrode tip and the fixed electrode tip to reach the two welding pressures, means for deriving a relational expression between the welding pressure and the movement amount based on the two welding pressures and the movement amounts, means for using the relational expression to estimate a movement amount required to generate, between the movable electrode tip and the fixed electrode tip, another welding pressure other than the two welding pressures among the plurality of welding pressures, means for identifying a torque required to move the movable electrode tip the estimated movement amount, and means for registering the torque required to move the estimated movement amount as a torque required to generate the another welding pressure between the movable electrode tip and the fixed electrode tip.

Hereinafter, a welding apparatus according to an embodiment of the present invention will be described with reference to the drawings. In the following description, constituent elements having substantially the same function and configuration are denoted by the same reference numeral, and repetitive descriptions will be given only where necessary.

The welding apparatus according to the present embodiment is an apparatus in which a spot welding gun is mounted on a robot arm mechanism so that the position and orientation of the spot welding gun can be changed. However, one feature of the welding apparatus according to the present embodiment lies in the method for calibrating the spot welding gun. Accordingly, the welding apparatus may be an apparatus in which the spot welding gun is mounted on another mechanism capable of changing the position and orientation of the spot welding gun. In addition, the spot welding gun can also be used as the welding apparatus on its own if the welding work can be performed using the spot welding gun.

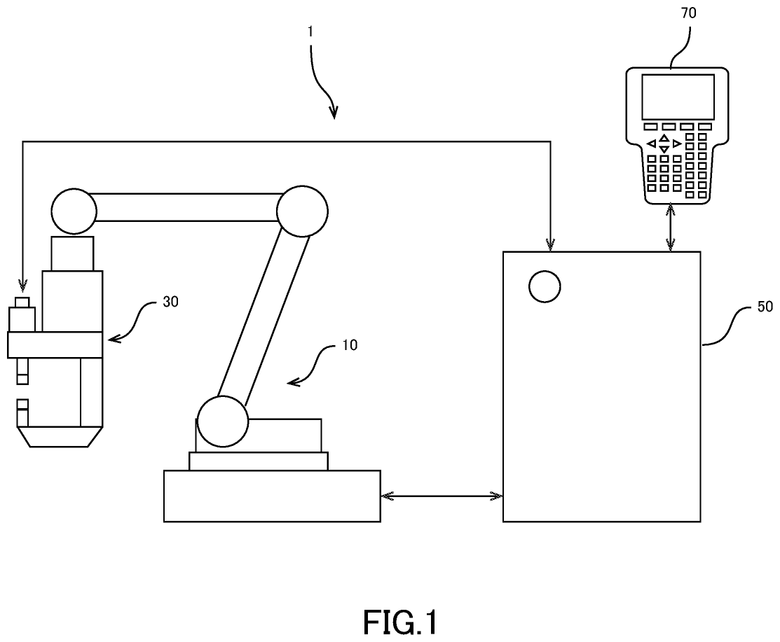

As shown in FIG. 1, a welding apparatus 1 includes a robot arm mechanism 10, a spot welding gun 30 mounted on the robot arm mechanism 10, a control device 50 that controls the operations of the robot arm mechanism 10 and the spot welding gun 30, and a teaching operation panel 70 communicatively connected to the control device 50.

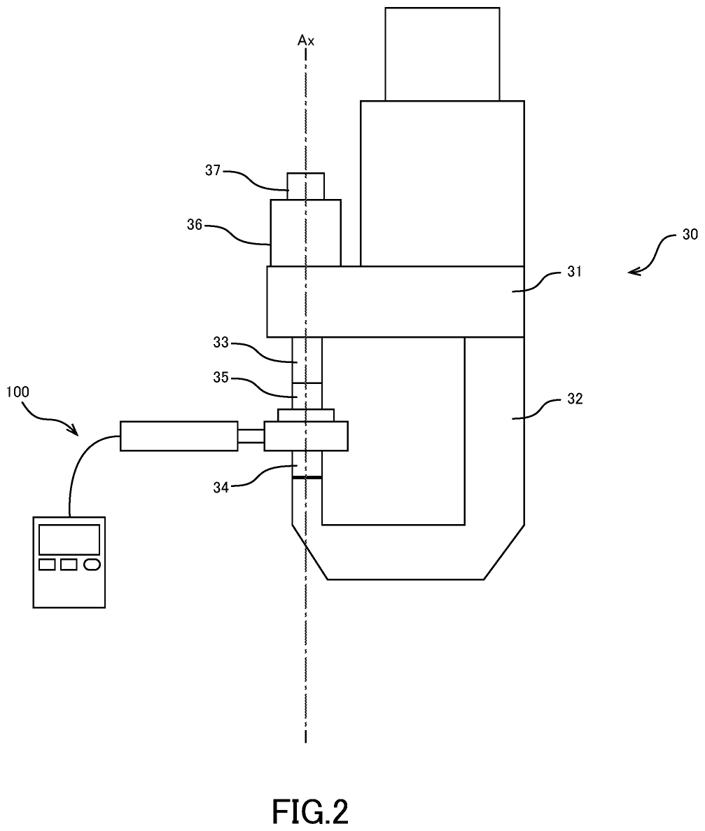

As shown in FIG. 2, the spot welding gun 30 includes a base portion 31, a fixed arm 32, a movable arm 33, and a pair of electrode tips. One electrode tip 34 (referred to as a fixed electrode tip 34) of the pair of electrode tips 34 and 35 is attached to the leading end of the fixed arm 32, and the other electrode tip 35 (referred to as a movable electrode tip 35) of the pair of electrode tips 34 and 35 is attached to the leading end of the movable arm 33. The shape, orientation, and position of each of the base portion 31, the fixed arm 32, and the movable arm 33 are designed so that the pair of electrode tips 34 and 35 can be disposed to face each other on a gun axis Ax.

For example, the base portion 31 is formed in a rectangular plate shape. The rod-shaped movable arm 33 is provided at the front end of the base portion 31 so as to be movable along the gun axis Ax. The fixed arm 32 is formed integrally with the base portion 31 at the rear end of the base portion 31. The fixed arm 32 is formed in, for example, a rod shape bent in a substantially U-shape so that the fixed electrode tip 34 provided at its leading end is disposed on the gun shaft Ax and faces the movable electrode tip 35 attached to the leading end of the movable arm 33.

The movement of the movable arm 33 is driven by a drive mechanism. The drive mechanism is provided in the base portion 31 and includes a servo motor 36 that generates power for driving the movement of the movable arm 33, and a conversion mechanism (not shown) that converts the rotational motion of the servo motor 36 into a linear motion along the gun axis Ax of the movable arm 33. The conversion mechanism may be any mechanism, such as a gear mechanism, a belt/pulley mechanism, or a combination thereof. When the servo motor 36 is driven, the movable electrode tip 35 moves back and forth along the gun axis Ax together with the movable arm 33 to approach and separate from the fixed electrode tip 34.

The servo motor 36 is driven by a current supplied from a motor driver 39. The servo motor 36 is provided with an encoder 37 that detects the rotational position of the drive shaft of the servo motor 36 and a torque sensor 38 that detects the torque generated on the drive shaft of the servo motor 36. The encoder 37 detects the rotational position of the drive shaft of the servo motor 36 and transmits it to the control device 50. The encoder 37 functions as a position detection unit that detects the position of the movable arm 33 by detecting the rotational position of the drive shaft of the servo motor 36. As an alternative to the encoder 37, the position detection unit may be constituted by a Hall element. The torque sensor 38 can employ any existing sensor, such as a strain gauge type, or a non-contact type. The torque sensor 38 detects the torque actually generated on the drive shaft of the servo motor 36 and transmits it to the control device 50.

In accordance with the control of the control device 50, the robot arm mechanism 10 places a workpiece to be welded between the pair of electrodes 34 and 35 of the spot welding gun 30. Thereafter, the servo motor 36 is controlled by the control device 50 to move the movable electrode tip 35 toward the fixed electrode tip 34, and the workpiece to be welded is held between the movable electrode tip 35 and the fixed electrode tip 34 and pressurized with a predetermined welding pressure. In accordance with the control of the control device 50, the fixed electrode tip 34 and the movable electrode tip 35 are energized, and the workpiece to be welded held between the fixed electrode tip 34 and the movable electrode tip 35 is spot welded.

The control device 50 includes hardware similar to that of a general PC or the like. Specifically, the control device 50 includes a processor configured by a CPU, a GPU, and the like, a RAM that functions as a main memory, a work area, and the like of the processor, and a storage device storing various programs, various types of setting information, and the like. The storage device stores a calibration program for the welding pressure/torque of the spot welding gun 30, a control program for operating a robot apparatus including the spot welding gun 30 and the robot arm mechanism 10, and data such as constants, variables, and setting values required when the spot welding gun 30 is operated.

When the calibration program is executed by the processor, the control device 50 functions as a torque identification unit 51, a movement amount identification unit 52, a formulation processing unit 53, a movement amount estimation unit 54, a screen generation unit 55, and a motor control unit 56.

The torque identification unit 51 is means for identifying the torque generated on the drive shaft of the servo motor 36 based on the output of the torque sensor 38. Here, the torque identification unit 51 identifies the torque of the drive shaft of the servo motor 36. However, the torque identified by the torque identification unit 51 is not limited to the torque of the drive shaft of the servo motor 36 as long as the torque can be correlated with the torque generated by the servo motor 36. For example, the torque identification unit 51 may identify the torque of another shaft to which the rotation of the servo motor 36 is transmitted, based on the output of a torque sensor provided on the other shaft. Alternatively, the torque identification unit 51 may identify, as the torque, a torque command value transmitted from the motor control unit 56 to the motor driver 39. The torque identification unit 51 estimates the torque for moving the movable electrode tip 35 a movement amount estimated by the movement amount estimation unit 54 to be described later.

The movement amount identification unit 52 identifies the movement amount (first movement amount) of the movable electrode tip 35, which moves along the gun axis Ax, based on the output of the encoder 37. Here, the movement amount is a parameter indicating how far the movable electrode tip 35 is pushed in from the position where the movable electrode tip 35 is in contact with an object to be contacted such as the workpiece to be welded, the welding pressure sensor 100, the fixed electrode tip 34, or the like. The point in time when the movable electrode tip 35 comes into contact with the object to be contacted can be identified based on the output of the torque sensor 38, for example. Of course, the means is not limited to this, and a contact sensor, an external image sensor, or the like can be used as long as the contact of the movable electrode tip 35 with the object to be contacted can be detected. As being based on the output of the encoder 37, the movement amount of the movable electrode tip 35 corresponds to the rotation amount of the drive shaft of the servo motor 36, not the physical movement amount of the movable electrode tip 35. Hereinafter, the term “movement amount” refers to the movement amount of the movable electrode tip 35.

The formulation processing unit 53 is means for formulating the relationship between the welding pressure and the movement amount based on at least two welding pressures and the movement amounts when the welding pressures are generated between the movable electrode tip 35 and the fixed electrode tip 34. For example, the formulation processing unit 53 holds a linear function formula as a relational expression model, and finds the constants of the linear function formula using two welding pressures and the movement amounts when the welding pressures are exerted to formulate a relational expression. The relational expression model is not limited to a linear function, and any formula can be adopted. Depending on the relational expression model, the number of welding pressures/movement amounts required to find the constants varies.

Based on at least two welding pressures and the movement amounts when those welding pressures are generated between the movable electrode tip 35 and the fixed electrode tip 34, the movement amount estimation unit 54 estimates the movement amount (second movement amount) of the movable electrode tip 35 for generating another welding pressure. Specifically, the movement amount estimation unit 54 estimates the movement amount (second movement amount) for the welding pressure between the movable electrode tip 35 and the fixed electrode tip 34 to reach a predetermined welding pressure, using the relational expression between the welding pressure and the movement amount formulated by the formulation processing unit 53.

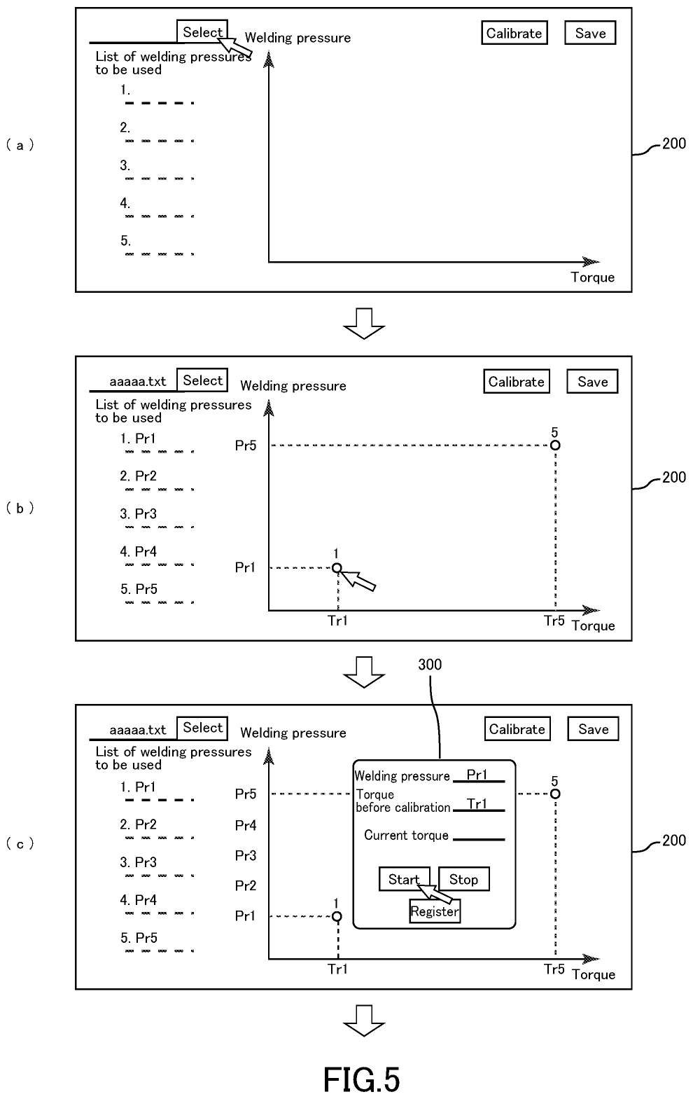

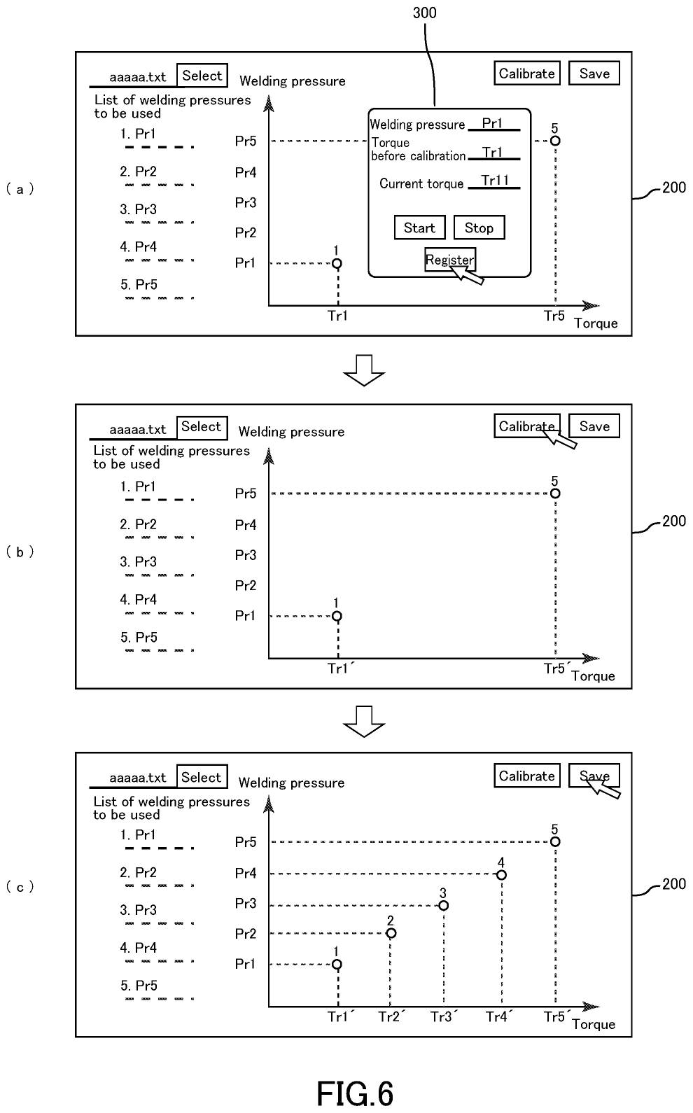

The screen generation unit 55 generates screen data to be displayed on a display unit of the teaching operation panel 70. Specifically, data of a calibration screen 200 (see FIG. 5(a) and the like) for calibrating the welding pressure/torque relationship is generated. Further, data of a measurement window 300 (see FIG. 5(c) and FIG. 6(a)) for measuring the predetermined welding pressure when identifying the torque at the predetermined welding pressure using the welding pressure sensor 100 is generated. The calibration screen 200 corresponds to means for prompting the user to input a plurality of welding pressures to be used for welding. The measurement window 300 corresponds to means for prompting the user to input a command indicating that the welding pressure between the movable electrode tip 35 and the fixed electrode tip 34 has reached each of the two welding pressures among a plurality of welding pressures.

The motor control unit 56 transmits a torque command to the motor driver 39 of the servo motor 36 in order to control the servo motor 36. The motor driver 39 supplies a current corresponding to the torque command received from the motor control unit 56 to the servo motor 36. Accordingly, the servo motor 36 is driven with a predetermined torque. In the present embodiment, the motor control unit 56 controls the servo motor 36 so that the torque gradually increases based on the click of a start button on the measurement window 300 displayed on the teaching operation panel 70. Further, the motor control unit 56 controls the servo motor 36 so that the torque gradually increases until the movement amount of the movable electrode tip 35 identified by the movement amount identification unit 52 reaches the movement amount estimated by the movement amount estimation unit 54, based on the click of a calibration button on the calibration screen 200 displayed on the teaching operation panel 70.

The teaching operation panel 70 functions as a display unit 72 for the user to browse various types of information from the control device 50, and an input unit 71 for the user to input various types of information to the control device 50. The display unit 72 is constituted by an LCD or the like. The input unit 71 is constituted by a keyboard or the like. Of course, they may be constituted by a touch panel display which serves both as the input unit 71 and the display unit 72.

The input unit 71 receives a plurality of welding pressures to be used for welding from the user. The plurality of welding pressures may be directly input by the user, or may be input by preparing data of a plurality of tables in each of which a plurality of welding pressures to be used are registered in advance and importing data of a table selected by the user. The input unit 71 also receives a command from the user indicating that the welding pressure between the movable electrode tip 35 and the fixed electrode tip 34 has reached each of the minimum welding pressure and the maximum welding pressure, during a trial period in which the servo motor 36 is driven while gradually increasing the torque. The control device 50 thereby receives, via the input unit 71, a designation of a plurality of welding pressures and a designation of the welding pressure between the movable electrode tip 35 and the fixed electrode tip 34 having reached each of two of the plurality of welding pressures. The display unit 72 displays the calibration screen 200 and the measurement window 300 generated by the screen generation unit 55 of the control device 50.

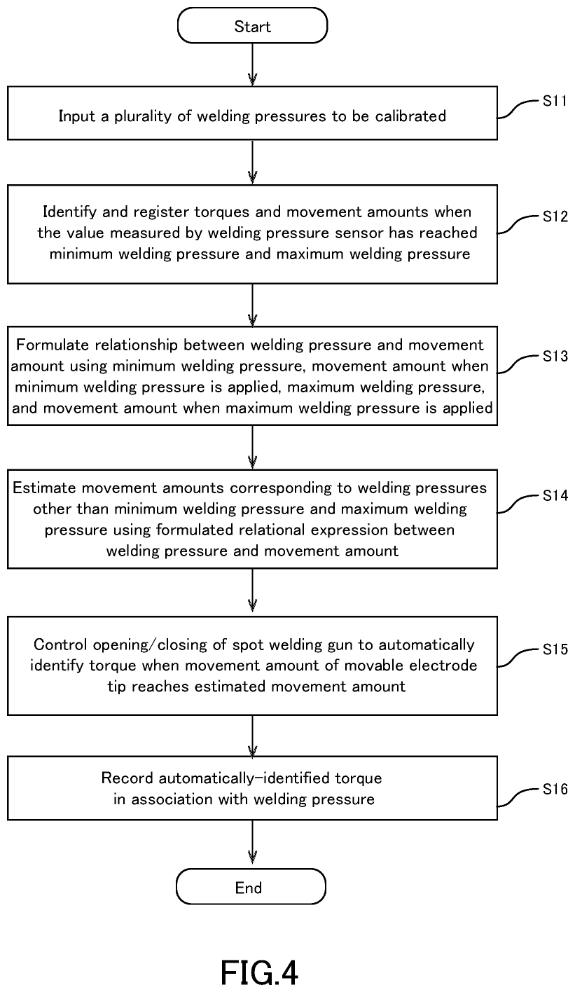

Referring to FIG. 4 to FIG. 7, a method for calibrating the welding pressure/torque relationship will be described below. The calibration of the welding pressure/torque can be advanced by user's operations on the calibration screen 200 and the measurement window 300 displayed on the teaching operation panel 70. The calibration screen 200 transitions in the order of FIG. 5(a). FIG. 5(b), FIG. 5(c), FIG. 6(a). FIG. 6(b), and FIG. 6(c).

As shown in FIG. 5(a), the calibration screen 200 includes a select button for selecting a data table relating to a plurality of welding pressures registered in advance, a display area of a list of welding pressures to be calibrated, a graph showing a relationship between welding pressures and torques, a calibrate button for starting automatic calibration, and a save button for saving a relationship between welding pressures and torques after calibration. The measurement window 300 is superimposed on the calibration screen 200 by clicking a welding pressure point plotted on the graph of the calibration screen 200. As shown in FIG. 5(c), the measurement window 300 includes a display area of a welding pressure, a display area of a torque before calibration, a display area of the current torque, a start button for starting a closing operation (pressurizing operation) of the spot welding gun 30, a stop button for stopping the closing operation (pressurizing operation) of the spot welding gun 30, and a register button for registering the current torque.

As shown in FIG. 4, when the calibration of the welding pressure/torque is started, the control device 50 registers a plurality of welding pressures Pr1, Pr2, Pr3, Pr4, and Pr5 to be calibrated, which are input by the user (S11), Specifically, when the user clicks the select button on the calibration screen 200, a plurality of files in each of which the welding pressures to be used are recorded are displayed. When the user selects a specific file (aaaaa.txt) from the plurality of files, a plurality of welding pressures recorded in the specific file are input to the control device 50 as the welding pressures to be calibrated. This completes the process of step S11, and as shown in FIG. 5(b), a plurality of welding pressures Pr1, Pr2, Pr3, Pr4, and Pr5 recorded in the specific file are displayed in the display area of welding pressures. Of the plurality of welding pressures Pr1, Pr2, Pr3, Pr4, and Pr5, the minimum welding pressure Pr1 and the maximum welding pressure Pr5 are automatically extracted and plotted on a graph with the welding pressure and the torque as the two axes. At this time, the torques Tr1 and Tr5 corresponding to the welding pressures Pr1 and Pr5, respectively, are the torques before calibration. The two welding pressures Pr1 and Pr5 are the welding pressures to be calibrated actually using the welding pressure sensor 100.

Referring back to FIG. 4, after the process of step S11, the welding apparatus 1 registers the torques Tr1′ and Tr5′ and the movement amounts Gm1 and Gm5 when the welding pressure between the movable electrode tip 35 and the fixed electrode tip 34 reaches the minimum welding pressure Pr1 and the maximum welding pressure Pr5, respectively (S12), Step S12 is a step involving user's work using the welding pressure sensor 100.

The procedure of the user's work using the welding pressure sensor 100 is as follows. The user sets the sensor main body of the welding pressure sensor 100 between the movable electrode tip 35 and the fixed electrode tip 34, Next, through an operation on the calibration screen 200, the user selects the welding pressure to be calibrated using the welding pressure sensor 100, For example, as shown in FIG. 5(b), by clicking a point corresponding to the minimum welding pressure Pr1, the minimum welding pressure Pr1 can be selected as the welding pressure to be calibrated. When a point corresponding to the minimum welding pressure Pr1 is clicked, the measurement window 300 is displayed.

As shown in FIG. 5(c), when the start button on the measurement window 300 is clicked by the user, the torque of the servo motor 36 is gradually increased by the control device 50, and the welding pressure value measured by the welding pressure sensor 100 is gradually increased. The user monitors the welding pressure value measured by the welding pressure sensor 100, and when the welding pressure value reaches the minimum welding pressure Pr1, the user clicks the stop button on the measurement window 300 to stop the control of the servo motor 36, The control device 50 identifies the torque Tr11 at the point in time when the stop button is clicked based on the output of the torque sensor 38, and identifies the movement amount Gm based on the output of the encoder 37.

As shown in FIG. 6(a), the torque Tr11 at the point in time when the stop button is clicked is displayed in the display area of the current torque on the measurement window 300, When the register button on the measurement window 300 is clicked by the user, the torque Tr11 and the movement amount Gm at the point in time when the stop button is clicked are registered as the torque Tr1′ and the movement amount Gm1 when the minimum welding pressure Pr1 is applied.

Referring back to FIG. 4, after the process of step S12, the control device 50 derives a relational expression between the welding pressure and the movement amount using the minimum welding pressure Pr1, the maximum welding pressure Pr5, the movement amount Gm1 when the minimum welding pressure Pr1 is applied, and the movement amount Gm5 when the maximum welding pressure Pr5 is applied (S13.

After the process of step S13, the control device 50 uses the relational expression between the welding pressure and the movement amount to estimate the movement amounts Gm2, Gm3, and Gm4 when the welding pressures Pr2, Pr3, and Pr4 other than the minimum welding pressure Pr1 and the maximum welding pressure Pr5 among the plurality of welding pressures Pr1, Pr2, Pr3, Pr4, and Pr5 to be calibrated are applied between the movable electrode tip 35 and the fixed electrode tip 34, respectively (S14.

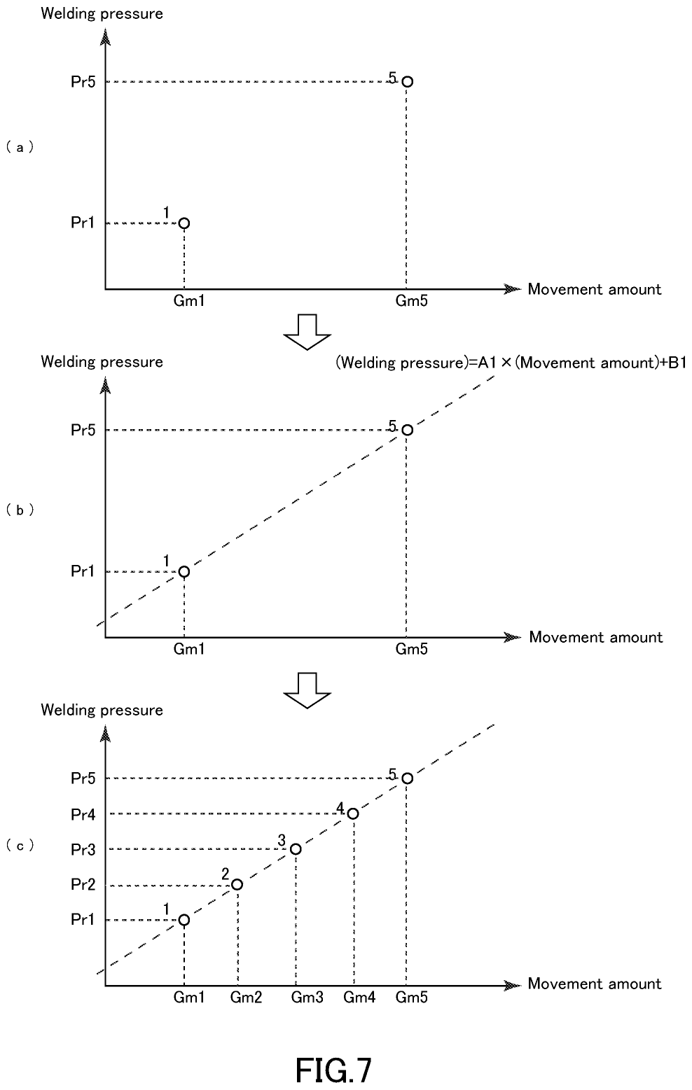

Step S13 and step S14 are internal processing of the control device 50, The processes of step S13 and step S14 will be described below with reference to FIG. 7, As shown in FIG. 7(a), since the movement amount Gm1 when the welding pressure Pr1 is applied and the movement amount Gm5 when the welding pressure Pr5 is applied are registered in the control device 50 at the end of step S12, two points can be plotted on the graph with the welding pressure and the movement amount as the X axis and the Y axis, respectively, Assuming that the relationship between the welding pressure and the movement amount is linear, the constants (A, B) of the linear expression ((welding pressure)=A×(movement amount)+B) of a linear function can be obtained from the above two points, By finding the constants (for example, by finding that the constant A is A1 and the constant B is B1), as shown in FIG. 7(b), the relational expression between the welding pressure and the moving amount ((welding pressure)=A1×(movement amount)+B1) can be formulated (step S13), Now that the relational expression between the welding pressure and the movement amount has been formulated, the movement amounts Gm2, Gm3, and Gm4 can be estimated by substituting the uncalibrated welding pressures Pr2, Pr3, and Pr4, respectively, into this relational expression (step S14.

Referring back to FIG. 4, after the process of step S14, the control device 50 controls the opening and closing of the spot welding gun 30, automatically identifies the torques when the movement amount of the movable electrode tip 35 reaches the movement amounts Gm2, Gm3, and Gm4 estimated in step S14 (S15), and registers the automatically identified torques as torques Tr2′, Tr3′, and Tr4 when the welding pressures Pr2, Pr3, and Pr4 are applied (S16.

Specifically, as shown in FIG. 6(b), when the user clicks the calibrate button on the calibration screen 200, the control device 50 controls the servo motor 36 to gradually increase the torque from the state where the movable electrode tip 35 is in contact with the fixed electrode tip 34, During this time, the control device 50 monitors the movement amount of the movable electrode tip 35 based on the output of the encoder 37, and monitors the torque generated on the drive shaft of the servo motor 36 based on the output of the torque sensor 38, The control device 50 identifies the torques at the points in time when the movement amount of the movable electrode tip 35 reaches the movement amounts Gm2, Gm3, and Gm4 estimated in step S14, respectively. The movement amounts Gm2, Gm3, and Gm4 are movement amounts estimated as the movement amounts when the welding pressures Pr2, Pr3, and Pr4 are applied using the relational expression between the welding pressure and the movement amount, Therefore, the torques at the points in time of reaching the movement amounts Gm2, Gm3, and Gm4 estimated in the step S14 can be regarded as the torques Tr2′, Tr3′, and Tr4 when the welding pressures Pr2, Pr3, and Pr4 are applied, After the process of step S15, as shown in FIG. 6(c), the torques Tr1′, Tr2′, Tr3′, Tr4′, and Tr5′ corresponding to the welding pressures Pr1, Pr2, Pr3, Pr4, and Pr5 to be used, which are to be calibrated, are obtained.

By the processes of step S11 to step S16, the calibration of the welding pressure/torque relationship is completed.

As described above with reference to FIG. 4 to FIG. 7, the welding apparatus 1 according to the present embodiment manually calibrate the welding pressure/torque relationship with respect to at least two welding pressures among a plurality of welding pressures using the welding pressure sensor 100, so that the welding apparatus 1 can automatically calibrate the welding pressure/torque relationship with respect to the other welding pressures instead of manually, Even if there are many welding pressure points to be used for welding work, such as 30 points, this allows the user to calibrate the pressure/torque relationship with respect to only two of those points using the welding pressure sensor 100, thereby significantly reducing the time required for calibration work compared to the conventional case where, when there are 30 welding pressure points to be used for welding work, the user had to manually perform calibration repeatedly with respect to the 30 points using the welding pressure sensor 100.

In order to achieve the above advantageous effects, the inventors have paid attention to the fact that the correlation between the welding pressure and the movement amount of the movable electrode tip 35 is high, and configured the welding apparatus 1 to obtain in step S12 the movement amounts Gm1 and Gm5, which are internal parameters of the welding apparatus 1, together with the torques Tr1′ and Tr5′ when the welding pressures Pr1 and Pr5 are applied, By formulating the relationship between the welding pressure and the movement amount, the movement amount required to obtain a specific welding pressure can be estimated. As described above, it is one of the features of the present application that the welding pressure, which is an external parameter that can be measured only by the external welding pressure sensor 100, is replaced with the movement amount of the movable electrode tip 35, which is an internal parameter that can be identified based on the output of the internal encoder 37, If the movement amount required to obtain a specific welding pressure can be estimated, the torque can be gradually increased little by little from the state where the movable electrode tip 35 is in contact with the fixed electrode tip 34, and the torque when the movement amount of the movable electrode tip 35 reaches the estimated movement amount can be obtained as the torque required to obtain the specific welding pressure, Although the welding pressure/torque must be manually calibrated with respect to the first two welding pressures, the step of obtaining the torques required to obtain the other welding pressures does not require the user's work using the welding pressure sensor 100 or the user's assistance, so that the user's calibration work can be greatly reduced.

In the present embodiment, the teaching operation panel 70 connected to the control device 50 has the functions of the input unit 71 and the display unit 72, but the configuration is not limited to that of the present embodiment as long as input information by the user can be input to the control device 50, For example, the control device 50 may have the functions of the input unit 71 and the display unit 72, Further, an external device communicatively connected to the control device 50 may be configured to have some functions such as calculation processing inside the control device 50.

In the present embodiment, the control device 50 controls the operation of the spot welding gun 30, but the embodiment is not limited to this as long as the operation of the spot welding gun 30 can be controlled. For example, the teaching operation panel 70 may have the function of the control device 50, and the spot welding gun 30 may be controlled by the teaching operation panel 70.

In the present embodiment, the minimum welding pressure and the maximum welding pressure are automatically extracted as the objects to be manually calibrated among the plurality of welding pressures, but the user may select any two welding pressures among the plurality of welding pressures, and the user can select the two welding pressures through the calibration screen 200.

In the present embodiment, the movable electrode tip 34 is assumed to move linearly along the gun axis Ax, which is represented by a straight line. However, the approach and separation path of the movable electrode tip 34 does not have to be a straight line as long as the movable electrode tip 35 can approach and separate from the fixed electrode tip 34, and when the movable electrode tip 35 approaches the fixed electrode tip 34, the movable electrode tip 35 faces the fixed electrode tip 34 on the gun axis Ax, and the workpiece to be welded can be held between the movable electrode tip 35 and the fixed electrode tip 34, In the present embodiment, of the pair of electrode tips 34 and 35, one electrode tip 34 is movable and the other electrode tip 35 is fixed, but one electrode tip 34 may be fixed and the other electrode tip 35 may be movable, or both of the pair of electrode tips 34 and 35 may be movable. In a configuration in which both of the pair of electrode tips 34 and 35 are movable and two servo motors are provided, the calibration of the welding pressure/torque described in the present embodiment may be performed for each of the two servo motors.

While some embodiments of the present invention have been described, these embodiments have been presented as examples, and are not intended to limit the scope of the invention. These embodiments can be implemented in various other forms, and various omissions, replacements, and changes can be made without departing from the spirit of the invention. These embodiments and their modifications are included in the scope and spirit of the invention and are included in the scope of the claimed inventions and their equivalents.

1. A welding apparatus provided with a welding gun including a servo motor configured to generate power for causing a movable electrode tip to approach and separate from a fixed electrode tip in order to pressurize a workpiece to be welded between the movable electrode tip and the fixed electrode tip for welding, the welding apparatus comprising:
means for prompting a user to input a plurality of welding pressures to be used for the welding;
means for prompting the user to input a command indicating that a welding pressure between the movable electrode tip and the fixed electrode tip has reached each of two welding pressures among the plurality of welding pressures;
means for identifying a torque exerted in the servo motor at a point in time when the command is input;
means for identifying movement amounts of the movable electrode tip required for the welding pressure between the movable electrode tip and the fixed electrode tip to reach the two welding pressures;
means for deriving a relational expression between the welding pressure and the movement amount based on the two welding pressures and the movement amounts;
means for using the relational expression to estimate a movement amount required to generate, between the movable electrode tip and the fixed electrode tip, another welding pressure other than the two welding pressures among the plurality of welding pressures;
means for identifying a torque required to move the movable electrode tip the estimated movement amount; and
means for registering the torque required to move the estimated movement amount as a torque required to generate the another welding pressure between the movable electrode tip and the fixed electrode tip.

2. The welding apparatus according to claim 1, wherein the two welding pressures are a minimum welding pressure and a maximum welding pressure among the plurality of welding pressures.

3. The welding apparatus according to claim 1, further comprising means for prompting the user to select the two welding pressures from the plurality of welding pressures to be used for the welding.

4. The welding apparatus according to claim 1, wherein the means for identifying the torque identifies the torque based on an output of a torque sensor provided in the servo motor.

5. The welding apparatus according to claim 1, wherein the means for identifying the movement amounts identifies each of the movement amounts based on an output of an encoder provided in the servo motor.

6. The welding apparatus according to claim 1, wherein the means for identifying the torque required to move the movable electrode tip the estimated movement amount controls the servo motor so as to gradually increase a torque from a state where the movable electrode tip is in contact with the fixed electrode tip, and identifies a torque when the movement amount of the movable electrode tip has reached the estimated movement amount as the required torque.

7. The welding apparatus according to claim 1, wherein the means for deriving the relational expression holds a linear expression model of a linear function, and obtains a constant of the linear expression model based on the two welding pressures and the movement amounts until the two welding pressures are exerted to derive the relational expression between the welding pressure and the movement amount.

8. A welding apparatus comprising a control device for controlling a servo motor configured to generate power for causing a movable electrode tip to approach and separate from a fixed electrode tip in order to pressurize a workpiece to be welded between the movable electrode tip and the fixed electrode tip for welding, wherein
the control device
accepts a designation of a plurality of welding pressures and a designation of a welding pressure between the movable electrode tip and the fixed electrode tip having reached each of two welding pressures among the plurality of welding pressures,
obtains first movement amounts of the movable electrode tip for reaching the two welding pressures,
estimates, based on the two welding pressures and the first movement amounts, a second movement amount of the movable electrode tip for generating another welding pressure different from the two welding pressures among the plurality of welding pressures, and
estimates a torque for the movable electrode tip to move the second movement amount.

9. A non-transitory storage medium storing a program causing a computer to implement: the computer controls a welding gun including a servo motor configured to generate power for causing a movable electrode tip to approach and separate from a fixed electrode tip in order to pressurize a workpiece to be welded between the movable electrode tip and the fixed electrode tip for welding;
prompting a user to input a plurality of welding pressures to be used for the welding;
prompting the user to input a command indicating that a welding pressure between the movable electrode tip and the fixed electrode tip has reached each of two welding pressures among the plurality of welding pressures;
identifying a torque exerted in the servo motor at a point in time when the command is input;
identifying movement amounts of the movable electrode tip required for the welding pressure between the movable electrode tip and the fixed electrode tip to reach the two welding pressures;
deriving a relational expression between the welding pressure and the movement amount based on the two welding pressures and the movement amounts;
using the relational expression to estimate a movement amount required to generate, between the movable electrode tip and the fixed electrode tip, another welding pressure other than the two welding pressures among the plurality of welding pressures;
identifying a torque required to move the movable electrode tip the estimated movement amount; and
registering the torque required to move the estimated movement amount as a torque required to generate the another welding pressure between the movable electrode tip and the fixed electrode tip.
